(19) United States
(12) Patent Application Publication
(10) Pub. No.: US 2007/0035671 A1
(43) Pub. Date: Feb. 15, 2007

(54) Liquid crystal television container

(76) Inventors: Doc Hee Ryu, Suwon-city (KR); Min Hwa Cho, Suwon-city (KR); In Sung Kim, Suwon-city (KR)

Correspondence Address: DITTHAVONG & MORI, P.C., Suite A, 10507 Braddock Road, Fairfax, VA, 22032, US

(21) Appl. No.: 11/370,678

(22) Filed: Mar. 8, 2006

(30) Foreign Application Priority Data
Aug. 10, 2005 (KR) 10-2005-0073355

(51) Int. Cl. H04N 5/64

(52) U.S. Cl. 348/794

(57) ABSTRACT

Disclosed is a liquid crystal television container. The user automatically adjusts the height of a liquid crystal television using a lifting device when the user wants to watch the liquid crystal television. The liquid crystal television is accommodated in the liquid crystal television container such that the liquid crystal television is protected from external impact when the user is not watching the liquid crystal television. The liquid crystal television container is equipped with wheels so that the user freely moves the liquid crystal television container. The liquid crystal television container includes a gate formed at an upper portion of the liquid crystal television container in such a manner that the gate is opened when a liquid crystal television moves upward and is closed when the liquid crystal television has been accommodated in the liquid crystal television container, a door hingedly coupled to the gate in order to open or close the gate, a frame base for fixedly mounting the liquid crystal television thereon, a frame lifting device for moving the frame base up and down, a controller for controlling a height of the liquid crystal television such that the liquid crystal television mounted on the frame base is fixed to a desired position, a driving unit including a motor operated according to a control signal generated from the controller, and a sensor for detecting a power-on signal of the liquid crystal television as power is applied to the liquid crystal television.

### BACKGROUND OF THE INVENTION

1. Field of the Invention

The present invention relates to a liquid crystal television container. More particularly, the present invention relates to a liquid crystal television container, in which a user can automatically adjust the height of a liquid crystal television using a lifting device when the user wants to watch the liquid crystal television and can accommodate the liquid crystal television in the liquid crystal television container such that the liquid crystal television can be protected from external impact when the user is not watching the liquid crystal television, and in which the liquid crystal television container is equipped with wheels so that the user can freely move the liquid crystal television container.

2. Description of the Prior Art

Recently, as various color liquid crystal televisions having slim sizes and wall decoration functions, such as flat LCD-televisions, PDP-televisions and projection-televisions, are available from markets, various liquid crystal television supporters having sizes corresponding to the sizes of the flat LCD-televisions, PDP-televisions and projection-televisions are provided in order to mount the flat LCD-televisions, PDP-televisions and projection-televisions.

However, since frames of the liquid crystal television supporters are exposed to the exterior so as to fix the liquid crystal television, the aesthetic appearance of the liquid crystal television supporters may be impaired. In addition, since the liquid crystal television supporters occupy relatively large spaces, the liquid crystal television supporters are inefficient in view of space use.

Moreover, since the liquid crystal television supporters fix the installation height of the liquid crystal televisions to a predetermined level, some viewers cannot watch the liquid crystal television at eye level. In other words, since the liquid crystal televisions are mounted on the liquid crystal television supporters at a fixed height, if viewers watch the liquid crystal televisions while sitting on a floor in a living room or a main room without using a chair or sitting on a sofa, the viewers must unnaturally raise their heads. If viewers watch the liquid crystal televisions in this posture for a long time, the bone structure of the viewers may be malformed.

In addition, when the viewer is not watching the liquid crystal television, children playing with toys or jumping around the area of the liquid crystal television may apply impact onto the liquid crystal television, causing damage to the surface of the liquid crystal television. Furthermore, the user may not easily move the liquid crystal television due to the weight of the liquid crystal television when it is necessary to shift the position of the liquid crystal television.

### SUMMARY OF THE INVENTION

Accordingly, the present invention has been made to solve the above-mentioned problems occurring in the prior art, and an object of the present invention is to provide a liquid crystal television container, in which a user can automatically adjust the height of a liquid crystal television using a lifting device when the user wants to watch the liquid crystal television, can accommodate the liquid crystal television in the liquid crystal television container such that the liquid crystal television can be protected from external impact when the user is not watching the liquid crystal television, and can utilize the liquid crystal television container as decoration furniture or a shelf, and in which the liquid crystal television container is equipped with wheels so that the user can freely move the liquid crystal television container.

In order to accomplish the above object, according to the present invention, there is provided a liquid crystal television container comprising: a gate formed at an upper portion of the liquid crystal television container in such a manner that the gate is opened when a liquid crystal television moves upward and is closed when the liquid crystal television has been accommodated in the liquid crystal television container; a door hingedly coupled to the gate in order to open or close the gate; a frame base for fixedly mounting the liquid crystal television thereon; a frame lifting device for moving the frame base up and down; a controller for controlling a height of the liquid crystal television such that the liquid crystal television mounted on the frame base is fixed to a desired position; a driving unit including a motor operated according to a control signal generated from the controller; and a sensor for detecting a power-on signal of the liquid crystal television as power is applied to the liquid crystal television.

According to the present invention, the liquid crystal television container can safely store the liquid crystal television therein and can be easily moved. In addition, the user can easily adjust the height of the liquid crystal television by using a remote controller or by operating a switch button of the controller without manually moving the liquid crystal television. Furthermore, since the frame base used for fixing the liquid crystal television is not exposed to the exterior, the aesthetic appearance of the liquid crystal television can be obtained and the efficiency of space use can be improved.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view illustrating a liquid crystal television container according to a first embodiment of the present invention;

FIG. 2 is a perspective view illustrating a liquid crystal television raised from a liquid crystal television container according to a first embodiment of the present invention;

FIG. 3 is a front perspective view illustrating a link unit of a liquid crystal television container according to a first embodiment of the present invention;

FIG. 4 is a side sectional view illustrating a link unit of a liquid crystal television container according to a first embodiment of the present invention;

FIG. 5 is a sectional view illustrating a front portion of a liquid crystal television accommodated in a liquid crystal television container according to a first embodiment of the present invention;

FIG. 6 is a sectional view illustrating a rear portion of a liquid crystal television accommodated in a liquid crystal television container according to a first embodiment of the present invention;

FIG. 7 is a sectional view illustrating a liquid crystal television raised from a liquid crystal television container according to a first embodiment of the present invention;

FIG. 8 is a sectional view illustrating a liquid crystal television raised from a liquid crystal television container according to a second embodiment of the present invention;

FIG. 9 is a side sectional view illustrating a liquid crystal television container according to a second embodiment of the present invention;

FIG. 10 is a sectional view illustrating a liquid crystal television raised from a liquid crystal television container according to a third embodiment of the present invention; and

FIG. 11 is a side sectional view illustrating a liquid crystal television container according to a third embodiment of the present invention.

### DETAILED DESCRIPTION OF THE PREFERRED EMBODIMENTS

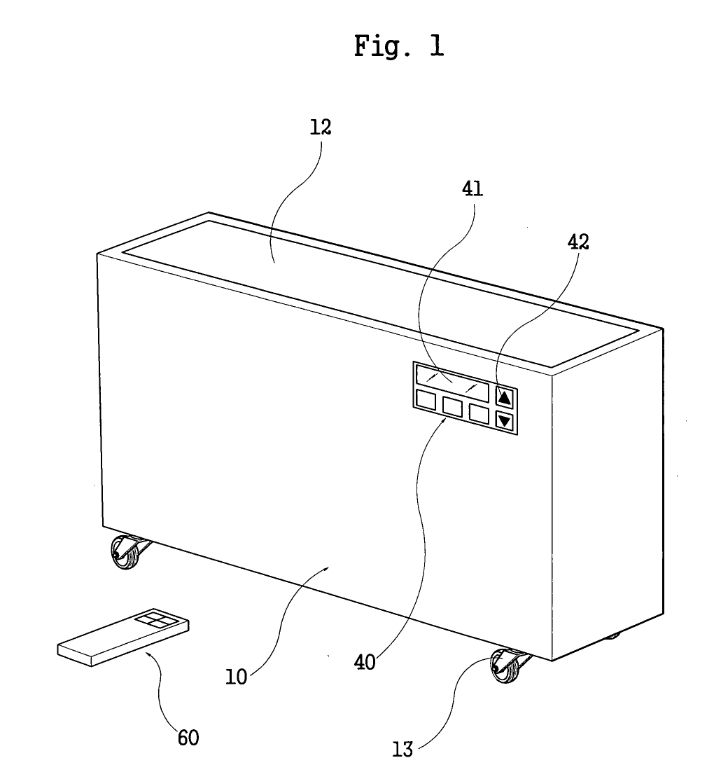

Hereinafter, the present invention will be described with reference to FIGS. 1 to 11.

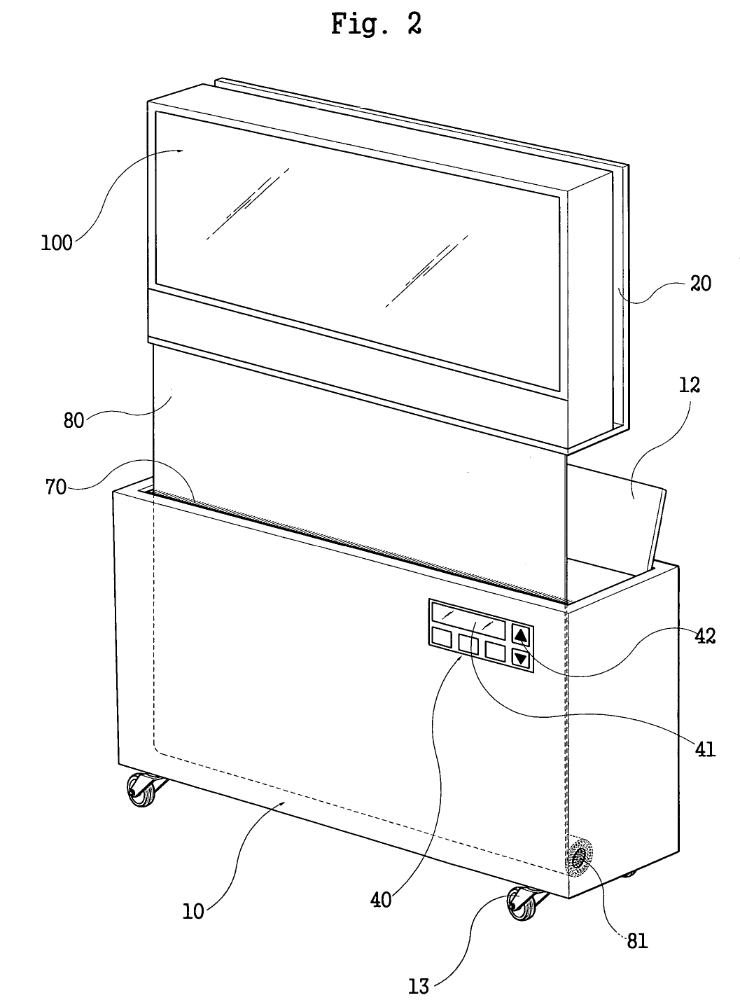

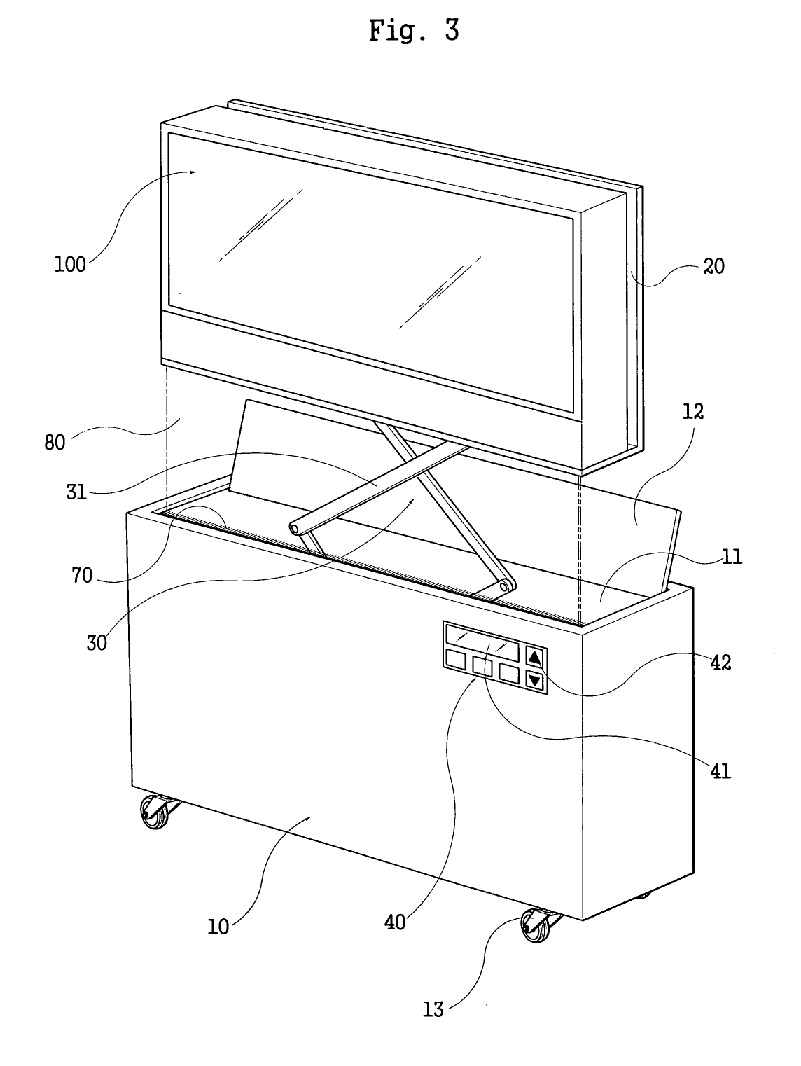

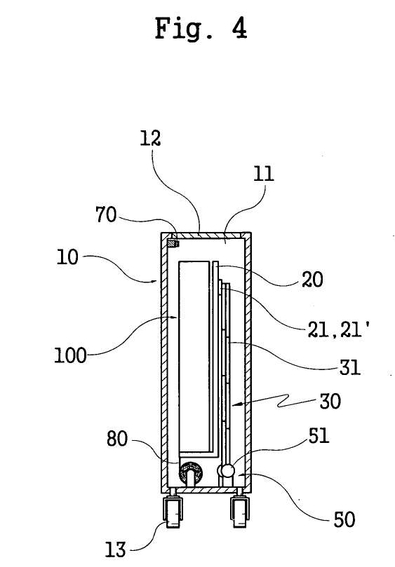

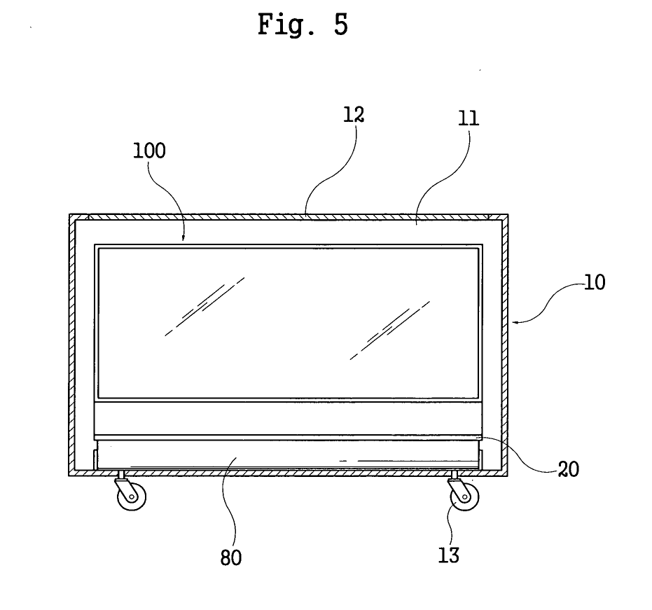

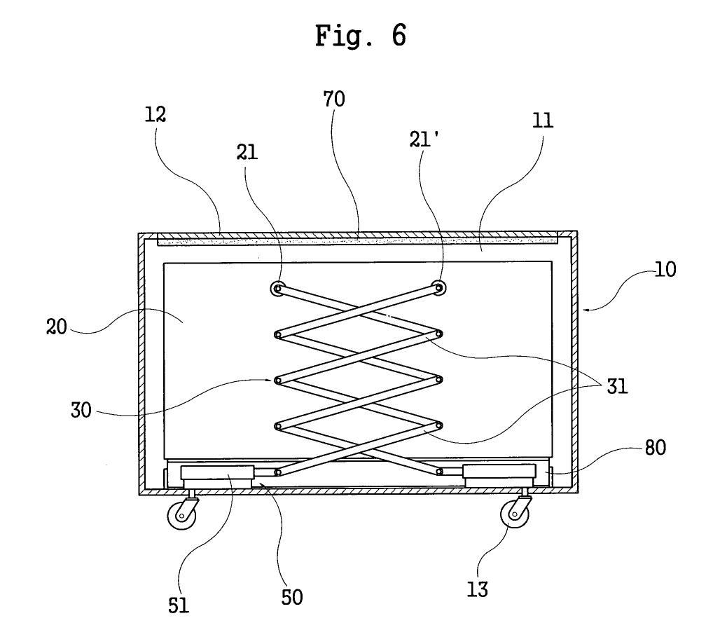

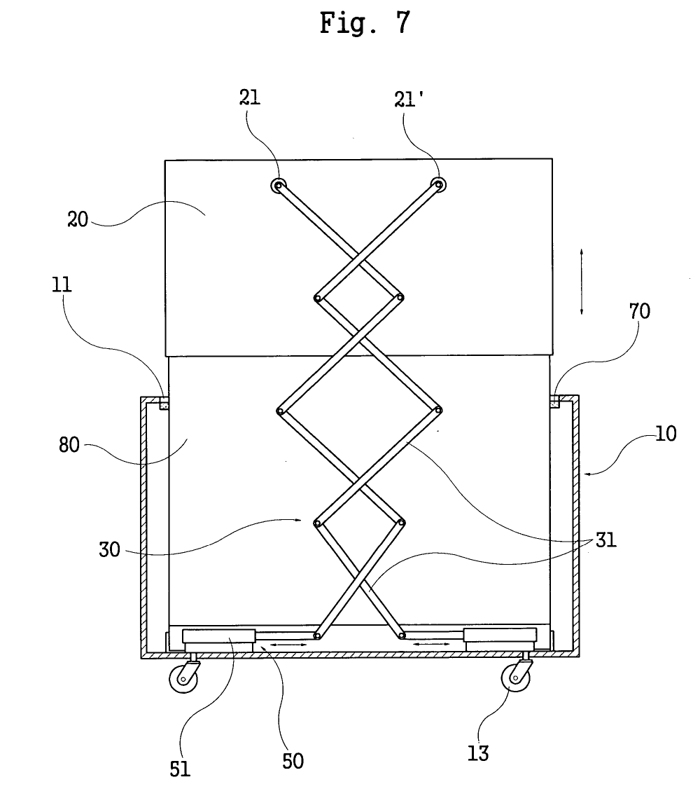

FIG. 1 is a perspective view illustrating a liquid crystal television container according to a first embodiment of the present invention, FIG. 2 is a perspective view illustrating a liquid crystal television raised from the liquid crystal television container according to the first embodiment of the present invention, FIG. 3 is a front perspective view illustrating a link unit of the liquid crystal television container according to the first embodiment of the present invention, FIG. 4 is a side sectional view illustrating the link unit of the liquid crystal television container according to the first embodiment of the present invention, FIG. 5 is a sectional view illustrating a front portion of the liquid crystal television accommodated in the liquid crystal television container according to the first embodiment of the present invention, FIG. 6 is a sectional view illustrating a rear portion of the liquid crystal television accommodated in the liquid crystal television container according to the first embodiment of the present invention, and FIG. 7 is a sectional view illustrating the liquid crystal television raised from the liquid crystal television container according to the first embodiment of the present invention.

### Embodiment 1

Hereinafter, a liquid crystal television container according to the first embodiment of the present invention will be described with reference to accompanying drawings. In the following description, the same reference numerals will be used for the same elements even if they are shown in different drawings.

The liquid crystal television container according to the present invention includes a frame lifting device 30 having a plurality of link units 31, which are fixedly coupled to a frame base 20 while being cross-connected with each other so as to move up and down the frame base 20. Thus, the height of a liquid crystal television 100 with respect to the ground can be adjusted according to the up/down movement of the links 31.

According to the present invention, the liquid crystal television includes various flat LCD-televisions, PDP-televisions or projection-televisions having slim sizes and wall decoration functions. In addition, the present invention provides a liquid crystal television container for installing the flat LCD-television, PDP-television or projection-television therein.

The liquid crystal television container 10 according to the present invention includes a screen 80, which is aligned between a bottom portion of the frame base 20 and an inner wall of the liquid crystal television container 10 and performs a rolling movement by means of a spring.

One end portion of the screen 80 is attached to a bottom wall of the liquid crystal television container 10 and the other end portion of the screen 80 is connected to the bottom portion of the frame base 20. Thus, when the frame base 20 is moved up, the screen 80 is deployed according to the movement of the frame base 20, thereby covering the frame lifting device 30 exposed to the exterior. At this time, springs are installed at one side of the frame lifting device 30 so as to apply tension to the screen 80. Accordingly, the screen 80 may be tightly deployed while covering a predetermined range from the lower portion of the frame base 20 to the upper portion of the liquid crystal television container 10, so that the frame base 20 and the frame lifting device 30 are not exposed to the exterior. Thus, the aesthetic appearance of the liquid crystal television can be improved.

A driving unit 50 includes a motor 51, which is driven according to a control signal generated from a controller 40. The driving unit 50 drives the frame lifting device 30. As the frame lifting device 30 is driven, the liquid crystal television 100 accommodated in the liquid crystal television container 10 is moved up or down through a door 12. At this time, the viewer can adjust the height of the liquid crystal television 100 according to eye level of the viewer using the controller 40.

When the door 12 is closed, the liquid crystal television container 10 is shielded from the exterior, so impurities or dusts may not penetrate into the liquid crystal television, keeping the liquid crystal television clean. In addition, the door 12 can be horizontally maintained when it is closed, so that the user can place items, such as accessories or watches, on the upper surface of the door 12.

The controller 40 is provided in the liquid crystal television container 10. The user can control the height of the liquid crystal television 100 by using the controller 40. In this regard, the controller 40 includes a button switch 42, which allows the user to manually control the height of the liquid crystal television. In addition, the liquid crystal television container 10 according to the present invention includes a remote controller 60, by means of which the user can operate the driving unit 50 such that the liquid crystal television 100 can be fixed at a predetermined height.

In addition, the user can operate the driving unit 50 using the controller 40 such that the liquid crystal television 100 can be fixed at a desired height corresponding to eye level of the user.

The liquid crystal television container 10 is provided at lower edges thereof with at least one wheel 13 so that the user can easily move the liquid crystal television container 10. For instance, the user can move the liquid crystal television container 10 to a desired place in a state in which the liquid crystal television has been accommodated in the liquid crystal television container 10.

According to the present invention, the user can manually or automatically operate the driving unit 50 so as to move up and down the liquid crystal television 100 through the door 12 positioned at the upper surface of the liquid crystal television container 10.

Accordingly, when the user is not watching the liquid crystal television 100, the user operates the driving unit 50 so as to move down the frame base 20 such that the liquid crystal television 100 can be accommodated in the liquid crystal television container 100. In this state, the user can store the liquid crystal television container 10 in the living room or the main room.

In addition, the present invention includes a sensor 41, which is connected to the controller 40 in order to operate the driving unit 50 by detecting a power-on signal when the user inputs the power-on signal using the remote controller 60 or a power switch. As the sensor 41 operates the driving unit 50, the door 12 is automatically opened so that the frame base 20 can be moved upward through the door 12.

The frame lifting device 30 includes a pair of fixing units 21 and 21′ for supporting the liquid crystal television 100.

In addition, a cleaning brush capable of preventing static electricity is provided at an inner portion of the liquid crystal television container 10.

The cleaning brush may remove impurities, such as dusts, from the surface of the liquid crystal monitor of the liquid crystal television 100 if the impurities are attached to the liquid crystal television 100 when the liquid crystal television 100 moves up and down in the liquid crystal television container 10. Thus, the liquid crystal monitor of the liquid crystal television 100 can be maintained in a clean state even if the user is not manually cleaning the liquid crystal monitor.

### Embodiment 2

Hereinafter, a liquid crystal television container according to the second embodiment of the present invention will be described.

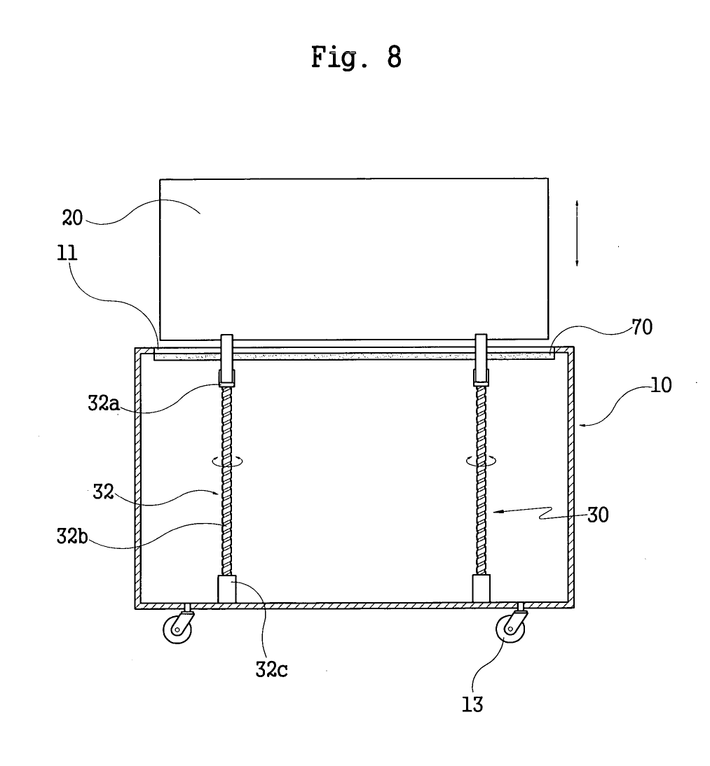

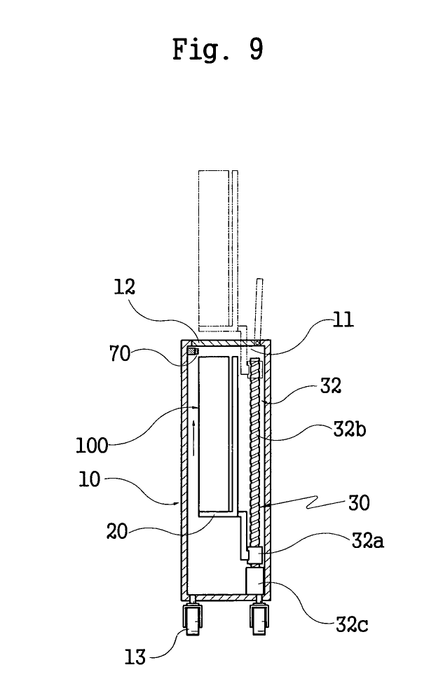

FIG. 8 is a sectional view illustrating the liquid crystal television raised from the liquid crystal television container according to the second embodiment of the present invention and FIG. 9 is a side sectional view illustrating the liquid crystal television container according to the second embodiment of the present invention. The second embodiment of the present invention is slightly modified from the first embodiment of the present invention. In the following description, the same reference numerals will be assigned to elements if the elements are identical to those of the first embodiment and description thereof will be omitted. FIGS. 8 and 9 represent the liquid crystal television container when the frame base is moved up and down, respectively.

According to the second embodiment of the present invention, the frame base 20 is regularly moved up and down in the liquid crystal television container 10 by means of screws.

As shown in FIG. 8, the frame lifting device 30 of the liquid crystal television container includes a screw unit 32 which is coupled with the frame base 20 in order to move up and down the frame base 20. The screw unit 32 includes a nut 32a, a screw shaft 32b coupled with the nut 32a such that the nut 32a can be moved up and down along the screw shaft 32b, and a first motor 32c for rotating the first screw shaft 32b in the forward or reverse direction.

In addition, according to the second embodiment of the present invention, it is possible to limit the movement range of the frame base 20 when the frame base 20 moves up and down by means of the screw unit 32.

As shown in FIGS. 8 and 9, the frame lifting device 30 adopts the screw unit 32, in stead of the link unit as shown in FIG. 1, so as to move up and down the frame base 20. That is, if the screw shaft 32b is rotated by means of the first motor 32c, the nut 32a fixed to the frame base 20 moves up or down along the screw shaft 32b, so that the frame base 20 also moves up or down along the screw shaft 32b.

Thus, if the user previously sets the desired height of the frame base 20, the controller 40 operates the screw unit 32 such that the frame base 20 can be moved up corresponding to the desired height, so that the user can watch the liquid crystal television while positioning the liquid crystal television at the desired height. In addition, according to the present invention, the aesthetic appearance of the liquid crystal television can be improved.

### Embodiment 3

Hereinafter, a liquid crystal television container according to the third embodiment of the present invention will be described.

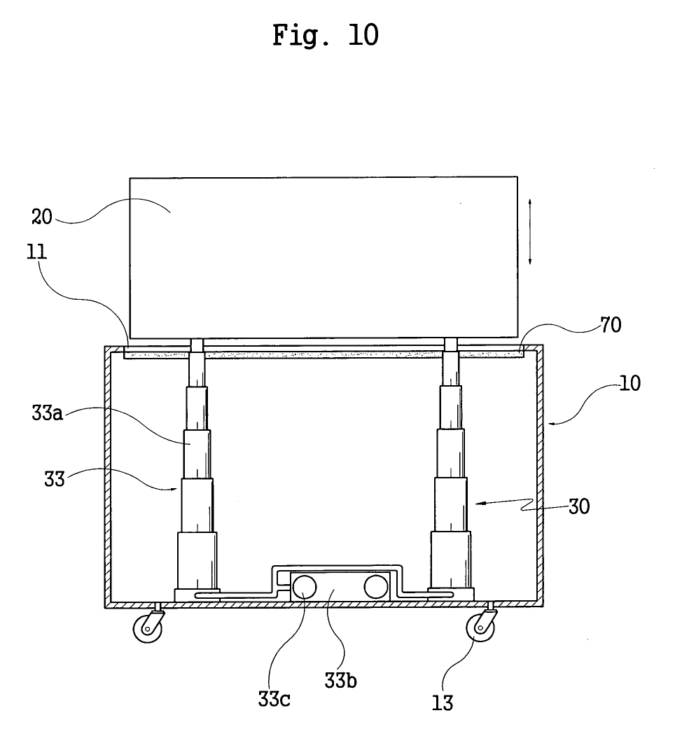

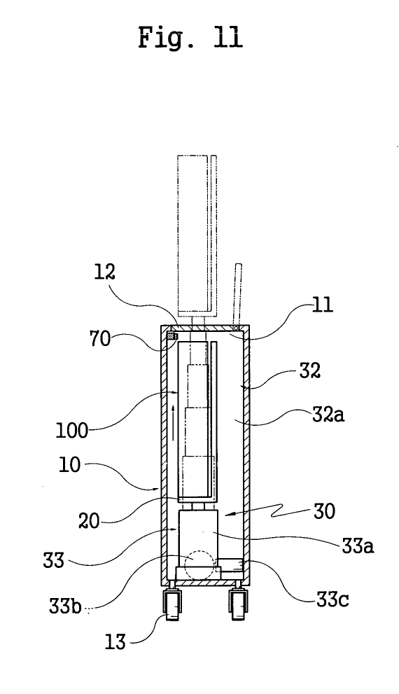

FIG. 10 is a sectional view illustrating the liquid crystal television raised from the liquid crystal television container according to the third embodiment of the present invention, and FIG. 11 is a side sectional view illustrating the liquid crystal television container according to the third embodiment of the present invention. In the following description, the same reference numerals will be assigned to elements if the elements are identical to those of the first and second embodiments and description thereof will be omitted. FIGS. 10 and 11 represent the liquid crystal television container according to the third embodiment of the present invention when the frame base is moved up and down, respectively, by means of a foldable telescopic lifter 33.

According to the third embodiment of the present invention, the frame lifting device 30 includes the foldable telescopic lifter 33 having a foldable body 33a, a hydraulic cylinder 33b and an actuating pump 33c. The frame base 20 is linearly moved up and down by means of the foldable telescopic lifter 33. Although the frame base 20 is moved up and down in the same manner as the first and second embodiments of the present invention, the third embodiment of the present invention is different from the first and second embodiments of the present invention in that it employs the foldable telescopic lifter 33.

As shown in FIGS. 10 and 11, according to the third embodiment of the present invention, fluid pressure is applied to the foldable body 33a coupled to the lower portion of the frame base 20 by means of the actuating pump 33c, so that the foldable body 33a is expanded or shrunk. Thus, the frame base 20 is moved up and down. Preferably, a pair of foldable bodies 33a are coupled to the lower portion of the frame base 20 such that they are actuated by means of a pair of actuating pumps 33c. The user can easily operate the foldable telescopic lifter 33 by manipulating a button of the controller 40.

According to the third embodiment of the present invention, the user can efficiently use the internal space of the liquid crystal television container. In addition, since the controller 40 is installed at a front of the liquid crystal television container, the user can easily operate the controller 40.

As described above, according to the present invention, the liquid crystal television can be safely stored in the liquid crystal television container such that the liquid crystal television can be protected from external impact when the user is not watching the liquid crystal television. In addition, the user can automatically adjust the height of the liquid crystal television using the lifting device when the user wants to watch the liquid crystal television. Furthermore, the user can utilize the liquid crystal television container as decoration furniture or a shelf. In addition, since the liquid crystal television container is equipped with wheels, the user can freely move the liquid crystal television container, improving the efficiency of space use. The liquid crystal television container may serve as an interior decoration element when it is painted with predetermined colors.

In addition, when the liquid crystal television has been accommodated in the liquid television container, the door is closed so that impurities or dusts may not penetrate into the liquid crystal television. Thus, the liquid crystal television can be maintained in a clean state for a long time.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A liquid crystal television container comprising:
a gate formed at an upper portion of the liquid crystal television container in such a manner that the gate is opened when a liquid crystal television moves upward and is closed when the liquid crystal television has been accommodated in the liquid crystal television container;
a door hingedly coupled to the gate in order to open or close the gate;
a frame base for fixedly mounting the liquid crystal television thereon;
a frame lifting device for moving the frame base up and down;
a controller for controlling a height of the liquid crystal television such that the liquid crystal television mounted on the frame base is fixed to a desired position;
a driving unit including a motor operated according to a control signal generated from the controller; and
a sensor for detecting a power-on signal of the liquid crystal television as power is applied to the liquid crystal television.

2. The liquid crystal television container as claimed in claim 1, wherein the frame lifting device includes a plurality of link units, which are fixedly coupled to the frame base while being cross-connected with each other so as to move the frame base up and down, and the height of the liquid crystal television with respect to a ground is adjusted according to the up/down movement of the links.

3. The liquid crystal television container as claimed in claim 1, further comprising a screen, which is aligned between a bottom portion of the frame base and an inner wall of the liquid crystal television container and performs a rolling movement by means of a spring.

4. The liquid crystal television container as claimed in claim 1, further comprising a remote controller for allowing a user to automatically operate the driving unit such that the liquid crystal television is fixed at a desired height.

5. The liquid crystal television container as claimed in claim 1, wherein the liquid crystal television container is provided at a lower portion thereof with at least one wheel so that the liquid crystal television container is easily moved.

6. The liquid crystal television container as claimed in claim 1, further comprising a remote controller, which is connected to a driving circuit so as to allow a user to input a signal using the remote controller when it is necessary to move the frame base up or down.

7. The liquid crystal television container as claimed in claim 1, wherein the frame lifting device includes a pair of fixing units for supporting the liquid crystal television.

8. The liquid crystal television container as claimed in claim 1, further comprising a cleaning brush capable of preventing static electricity, wherein the cleaning brush is provided at an inner portion of the liquid crystal television container.

9. A liquid crystal television container comprising:
a gate formed at an upper portion of the liquid crystal television container in such a manner that the gate is opened when a liquid crystal television moves upward and is closed when the liquid crystal television has been accommodated in the liquid crystal television container;
a door hingedly coupled to the gate in order to open or close the gate;
a frame base for fixedly mounting the liquid crystal television thereon;
a frame lifting device for moving the frame base up and down, in which the frame lifting device includes a screw unit which is coupled with the frame base in order to move up and down the frame base, and the screw unit includes a nut, a screw shaft coupled with the nut such that the nut is moved up and down along the screw shaft, and a first motor for rotating the first screw shaft in a forward or a reverse direction;
a controller for controlling a height of the liquid crystal television such that the liquid crystal television mounted on the frame base is fixed to a desired position; and
a sensor for detecting a power-on signal of the liquid crystal television as power is applied to the liquid crystal television.

10. A liquid crystal television container comprising:
a gate formed at an upper portion of the liquid crystal television container in such a manner that the gate is opened when a liquid crystal television moves upward and is closed when the liquid crystal television has been accommodated in the liquid crystal television container;
a door hingedly coupled to the gate in order to open or close the gate;
a frame base for fixedly mounting the liquid crystal television thereon;
a controller for controlling a height of the liquid crystal television such that the liquid crystal television mounted on the frame base is fixed to a desired position;
a frame lifting device for moving the frame base up and down, in which the frame lifting device includes a foldable telescopic lifter having a plurality of foldable bodies, a hydraulic cylinder and actuating pumps for operating the foldable bodies, the foldable bodies performing a telescopic movement as a user operates a button of the controller; and
a sensor for detecting a power-on signal of the liquid crystal television as power is applied to the liquid crystal television.
